(19) United States
(12) Patent Application Publication
(10) Pub. No.: US 2022/0323281 A1
(43) Pub. Date: Oct. 13, 2022

(54) PATIENT BODY WEDGE AND REPOSITIONING DEVICE

(71) Applicant: Jeffrey Gainey, Peachtree City, GA (US)

(72) Inventor: Jeffrey Gainey, Peachtree City, GA (US)

(21) Appl. No.: 17/228,960

(22) Filed: Apr. 13, 2021

(51) Int. Cl. A61G 7/10

(52) U.S. Cl. CPC A61G 7/1026

(57) ABSTRACT

Disclosed is a padded body wedge-type cushion constructed in a specific shape and contour to facilitate a desired positioning of a patient by one or more caregivers. The disclosed body wedge comprises a sloped, flat planar front panel, a rounded apex top connecting the front panel to an integral vertical rear surface; identical left side and right side; a horizontally-oriented base panel having a non-slip material affixed exteriorly thereto, wherein the base panel is sequentially connected by stitched seams to the front panel, the left side, the vertical rear surface, and the right side of the wedge. A grip handle is fixed midway along the rear edge of the base panel, thereby rendering more effective positioning leverage for a user. A notification, reading “Patient Side,” is printed upon the front panel. The disclosed padded wedge provides an effective mechanism to effectuate repositioning of a prone, bedridden patient.

### CROSS-REFERENCES TO RELATED APPLICATIONS

Not applicable.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### BACKGROUND OF THE INVENTION

(1) Field of the invention

This invention relates to accessories and equipment used by medical personnel and caregivers in the handling of bedridden patients. Bedridden patients are often immobile and may be at risk for the forming of pressure sores or ulcers on their body. Pressure on a patient's skin, during extended periods of time, may cause pressure ulcers in areas where bone or cartilage is in very close proximity to the surface of the patient's skin.

One effective way to combat pressure ulcers or discomfort to a bedridden patient is to frequently turn the patient, along the patient's general linear body axis, so that the patient may be rotated. The rotations serve to assist the patient in resting on one side or the other, for short stretches of time. Specially-shaped pillows and contoured, flexible wedges are utilized on hospital mattresses to help in relieving some of the pressure of different body sections against the mattress. Pillows that are stuffed partially under the patient are often used to support the patient's upper body when resting on their left or right sides.

Turning patients can be difficult and time consuming for hospital staff or a caregiver, and frequently involves the coordination of two or more persons. Turning a patient can result in discomfort or injury to the patient, as well as to caregivers from pushing and pulling the patient's weight during turning maneuvers. Additionally, the pillows or wedges used in turning and supporting the patient are often non-uniform and can pose difficulty in achieving consistent turning angles, as well as occasionally slipping out from underneath the patient.

The disclosed body wedge 1 is intended to overcome the above-described limitations and difficulties, as it provides new features not hereto found in similar devices.

(2) Description of the Related Art, including information disclosed under 37 CFR 1.97 and 1.98. The following references describe materials and devices that have some similarity with regard to the intended functions available by means of use of Applicant's inventive concept:

U.S. Pat. No. 5,182,828; Feb. 2. 1993; Alivizatos; A machine washable wedge shaped support structure is formed from a fabric envelope loosely filled with lightweight, preferably polystyrene, beads which shape it. The fabric may have a non-skid surface to resist sliding in use. The wedge conforms to a patient's or infant's body. When compressed, the fabric envelope and beads lock into a roll-preventing support structure. One alternate version has a stabilizing panel extending from the pointed end of the wedge on which a patient lies. Another version has a connecting panel between two opposing triangular shaped wedges. It provides roil preventing support for a pregnant woman and doubles as an anti-roll pad for infants.

U.S. Pat. No. 7,240,384; Jul. 10, 2007; DuDonis; The patient positioning aid assists a caregiver in rotating and positioning immobile patients. Such patients require periodic movement to prevent the development of ulcers. Conventional methods use rolled blankets or pillows to support such patients. Such improvisations are often crushed by the patients, especially by bariatric patients. The present invention has a strong resilient foam core which resists compression by a patient, yet also has a yielding surface foam layer which avoids trauma to the patient's skin. The cover is removable for cleaning, waterproof, and utilizes an anti-slip, high friction coating on the bottom which resists sliding on the bed. In addition, handles on the caregiver side of the aid assist in the maneuvering of the aid to position it properly.

U.S. Pat. No. 9,381,107; Jul. 5, 2016; MacLeod; A post shoulder surgery rehabilitation apparatus in the form of a bed wedge having a shoulder support wedge structure attachment to provide the optimal support and comfort to a patient while resting or sleeping on a bed or similar structure. An exemplary embodiment of the bed wedge apparatus is capable of being inflated and deflated to the optimal angle for comfort and support for the repaired shoulder by means of a remote control switch by the patients themselves without assistance from a caregiver. Alternate embodiments of the bed wedge apparatus include ones without the need for inflation or deflation and ones that have shoulder support wedge structures for both shoulders after surgery.

U.S. Pat. No. 9,820,903; Nov. 21, 2017; Steffens, et al. A device for use with a bed having a frame and a supporting surface includes a flexible sheet with a tether strap connected to the sheet and extending from the sheet. The flexible sheet has opposed top and bottom surfaces, with the top surface having a high friction material with a higher coefficient of friction as compared to the bottom surface, which includes a low friction material. The tether strap is configured for connection to the frame of the bed to secure the sheet in place. A system incorporating the flexible sheet may also include an absorbent pad configured to be placed on the top surface of the sheet, where the high-friction top surface resists sliding of the absorbent pad, as well as one or more wedges having a base wall that the wedge rests on and a ramp surface configured to confront the sheet when the wedge is placed under the sheet. The base wall and the ramp surface may also contain high friction and low friction materials, respectively.

U.S. Pat. No. 7,171,710; Feb. 6, 2007; Mann; A system used for the prevention of positional plagiocephaly in which an infant receiving member includes an infant supporting surface, a first portion, and a second portion. An inclined member is positioned at least partially under the first portion of the infant receiving surface such that the first portion of the infant receiving surface is inclined.

### BRIEF SUMMARY OF THE INVENTION

The inventive concept disclosed is essentially a wedge type support cushion constructed in a specific shape and contour. The shape, contour, and other features of the body wedge 1 facilitate the proper positioning and re-positioning of a bedridden patient by one or more caregivers who make use of the patient body wedge 1. The disclosed patient body wedge 1 is intended, in static situations, to help support the upper and lower torso of the patient. A temporary static support positioning of the body wedge 1 will allow a patient to have a comfortable range of movement of his/her lower and upper extremities (dependent on the extent of the patient's injuries), thereby providing increased comfort and no interruption of the blood flow to various parts of the patient's anatomy.

A very important use of the patient body wedge 1 is to provide an effective mechanism whereby a patient's body may be repositioned in bed. A first body wedge 1 is arranged and deployed at least proximate the upper torso of the patient. A second patient body wedge 1 is used in coordination with the first body wedge 1 and may be positioned proximate the lower torso of the patient. Each of the patient body wedges 1 is constructed with a grip handle 24, which helps facilitate an efficient manner of maneuvering the body wedges 1 during movement or re-positioning the patient's body at certain time intervals, or moving the patient onto a different bed.

### BRIEF DESCRIPTION OF THE VIEWS OF THE DRAWINGS AS EXEMPLARY EMBODIMENTS OF THE INVENTIVE CONCEPT

FIG. 1 illustrates a perspective view of the body wedge 1 showing the sloped panel 3, the rounded apex 2, the left side 9, and the “PATIENT SIDE” notification 27.

FIG. 2 is a rear view of the body wedge 1, showing the rear surface 21, rounded apex 2, and the grip handle 24 of the patient body wedge 1.

FIG. 3 presents a left elevation view of the body wedge 1, showing the left side 9, round apex 2, and grip handle 24 of the patient body wedge 1.

FIG. 4 presents a bottom view of the outer surface of the base panel 22 of the invention, fully covered by a non-slip material, 23, and attachment points 17, for the grip handle 24.

FIG. 5 depicts a patient 31 lying prone upon a mattress/sheet 36 combination integral to a bed 38, with the patient's upper and lower torso 32, 33 being stabilized by a first body wedge 28 and a second body wedge 29.

### DETAILED DESCRIPTION OF THE INVENTION

The objects, features, and advantages of the inventive concept presented in this application are more readily understood when referring to the accompanying drawings. The drawings, totaling five figures, show the basic components and functions of embodiments and/or methods of use. In the several figures, like reference numbers are used in each figure to correspond to the same component as may be depicted in other figures.

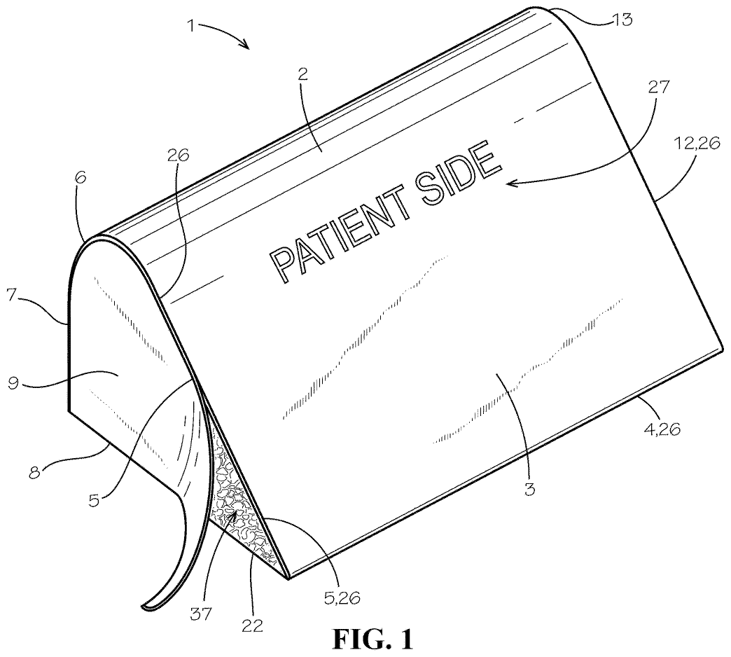

The discussion of the present inventive concept will be initiated with FIG. 1. In FIG. 1 there is illustrated a perspective view of the body wedge 1, showing the sloped panel 3, the rounded apex 2, the left side 9, and the “PATIENT SIDE” notification 27. The “PATIENT SIDE” notification 27, although shown written in English, this illustration is not meant as a limitation of the language of the notification 27. The notification 27 can be transcribed in any spoken language (for instance in Spanish, “LADO PACIENTE”), and serves to notify caregivers of the appropriate surface of the body wedge 1 to use in placement against a patient's 31 body.

In essence, FIG. 1 shows the body wedge 1 to be a shaped, padded wedge, having a quantity of pliable material 37 densely enclosed within the body wedge 1. FIG. 1 depicts a small portion of the left sidewall 9 peeled outward from the body wedge 1 to expose the interior pliable material 37. In the preferred embodiment, the pliable material 37 consists of polyurethane foam, which is contained within the interior volume of the body wedge 1.

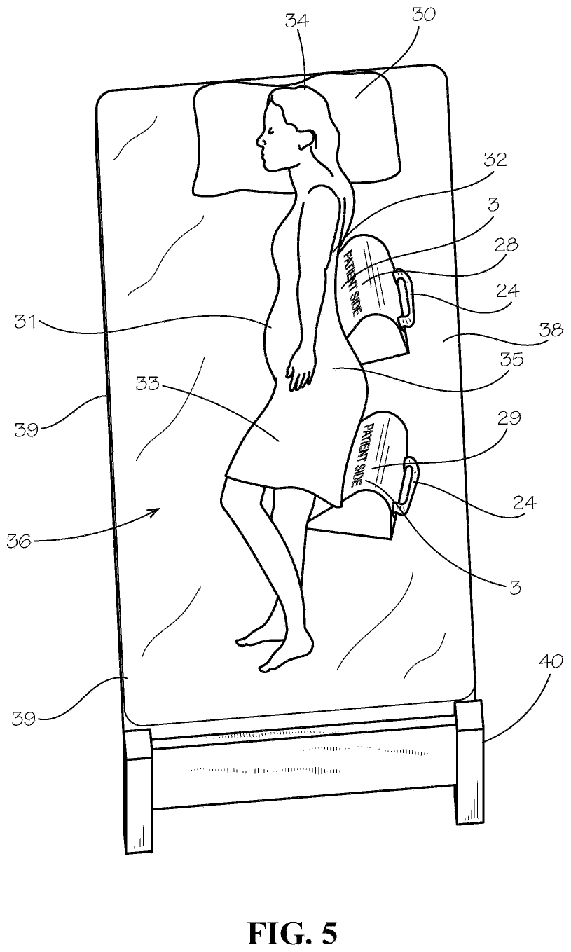

The body wedge 1 construction features a rectangular-shaped, sloped front panel 3 and a rounded apex 2. The rounded apex 2 of the body wedge 1 is contoured so as to provide a gentler and more widely-distributed pressure area on the back or torso 32, 33 of a patient 31, when the patient 31 is lying on his/her side. This rounded apex 2 provides more comfort for patients 31, versus the normal orthogonal straight-edge found on most body wedges used for patient care. Such prior art straight-edges often serve to initiate the beginning of a pressure injury to the back of the patient 31. Two body wedges 28, 29 are illustrated providing support to a patient 31 in FIG. 5 herein.

To further provide patient 31 comfort, the left rear edge 7 and rear surface 21 (out of view) of the body wedge 1 are constructed with a higher than normal vertical dimension when the body wedge 1 is placed atop a mattress surface than prior art body wedges. For patient 31 comfort and stabilization of the torso of a patient 31, the optimum angle between the sloped front panel 3 and the planar base panel 22 is thirty degrees.

Further, it is an objective of this inventive concept that the feature off higher than normal ratio of the vertical dimension of the rear surface 21 relative to the surface of the mattress, coupled with the rounded apex 2, provide a structure that helps eliminate the possibility of a pressure injury being inflicted on the patient's 31 back.

A further objective of this inventive concept is to provide materials of fabrication that are sanitizable, such that caregivers or care facilities may cleanse the exterior materials to render them free from viruses, germs, soils, and provide the capability of re-using the patient body wedge 1.

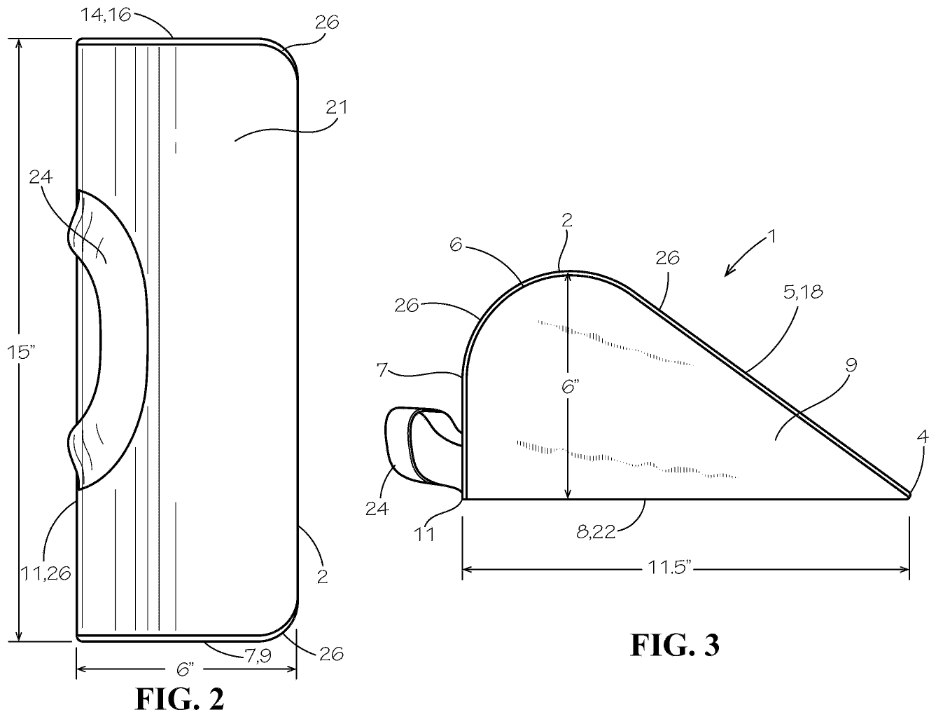

FIG. 2 displays a rear view of the body wedge 1, showing the rear surface 21, the rear segment of the rounded apex 2, and a grip handle 24. The grip handle 24 is affixed midway along the rear portion of the rear edge 10 of the base panel 22 (out of view, as the body wedge 1 rests atop the base panel 22). The rear edge 10 of the base panel 22 forms a junction with the bottommost portion of the rear surface 21, this junction rendered complete and functional by means of a stitched seam 26.

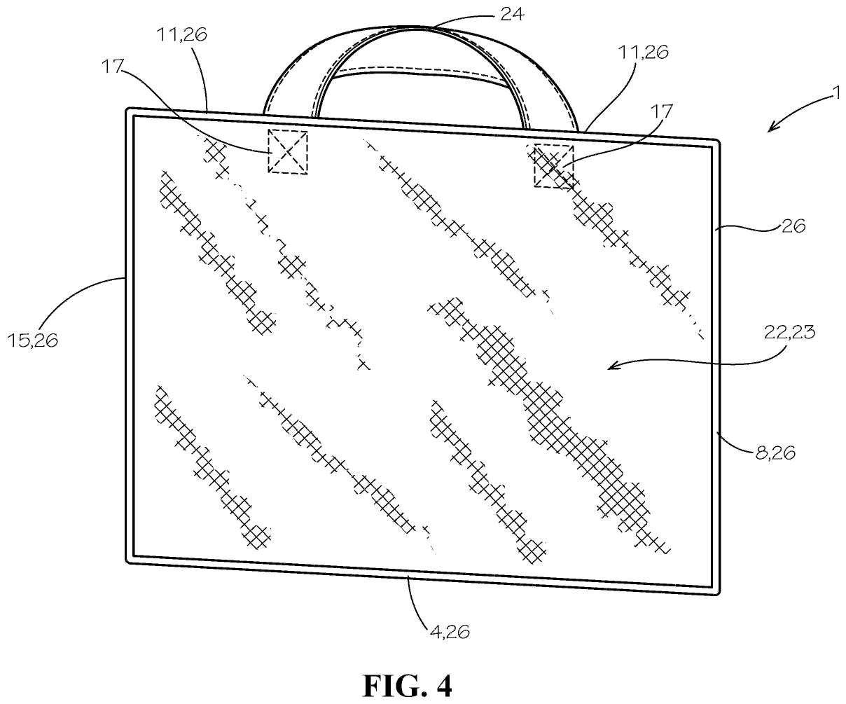

The grip handle 24, in the preferred embodiment, attached to the base panel 22 at attachment points 17, as is more clearly depicted in FIG. 4. The grip handle 24 is further, affixed at two attachment points 17, to the rear edge of the base panel 22, the attachment points 17 being linearly parallel to the rear edge 11 of the base panel 22. The grip handle 24 serves to facilitate handling and positioning of the body wedge 1 when caregivers or medical personnel are actively involved in efforts to reposition or move a patient 31.

In FIG. 2, the height of the rear surface 24 is depicted as 6.0 inches, while the width of the rear surface 24 is indicated as 15.0 inches. These dimensions are within the range of the optimum ratio, one to the other, for providing the most effective inclination of the sloped front panel 3 of the patient body wedge 1. Further, the dimensional ratio of the width of the rear surface 24 to the height of the rear surface 24 provides ease of maneuverability and leverage for care givers who use the patient body wedge 1. These recited dimensions in FIG. 2 are for optimum sizing of the patient body wedge 1, for illustrative purposes, and are not intended as functional or design size limitations of the patient body wedge 1.

FIG. 3 presents a left elevation view of the body wedge 1, showing the left sidewall 9, rounded apex 2, and grip handle 24 of the patient body wedge 1. As shown by FIG. 3, the left sidewall 9, as used in practical applications, is vertical and shaped essentially as a right triangle, one leg of the triangle being a horizontal base edge 8, a shorter leg being the vertical left rear edge 7, and a segment that can be termed as a hypotenuse 18, being the left upper edge 5 of the body wedge 1. The projected intersection of the left rear edge 7 and the left upper edge 5 is instead supplanted by the fabricating of the rounded apex 2.

The identical triangular design contour, as described above, also exists for the right sidewall 16 (not in view). This symmetry thereby renders the left rear edge 7 and right rear edge 14 of the body wedge 1 parallel and mutually coextensive. Further, the front edge 4 of the base panel 22 and the base rear edge 11 of the base panel 22 are parallel and mutually coextensive. The base panel 22 comprises an inner surface and an outer surface. In the preferred embodiment, the sloped front panel 3 of the body wedge 1 is fabricated so as to be oriented at a thirty-degree angle from the plane of the base panel 22.

The left upper edge 5 of the left sidewall 9 is connected, by a seam 26, to the sloped front panel 3 (more readily seen in FIG. 1), as is the left rear edge 7 of the left sidewall 9 connected by a seam 26 to the rear surface 21 of the body wedge 1. The right sidewall 16, of the body wedge 1 is not in view, however, the right sidewall 16 is also connected by seams 26 to the sloped front panel 3 at the right upper edge 12 (as shown in FIG. 1) and the right rear edge 14 of the rear surface 21.

In FIG. 3. the height of the rear surface 24 is depicted as 6.0 inches, while the length of the rear surface 24 is indicated as 11.5 inches. These dimensions are within the range of the optimum ratio, one to the other, for providing the most effective inclination of the sloped front panel 3 of the patient body wedge 1. Further, the dimensional ratio of the rear surface 24 to the height of the rear surface 24 provides ease of maneuverability and leverage for users of the patient body wedge 1. These recited dimensions in FIG. 2 are for optimum sizing of the patient body wedge 1, for illustrative purposes, and are not intended as functional or design size limitations of the patient body wedge 1.

FIG. 4 presents a view of the outer surface, of base panel 22 of the body wedge 1, being fully covered by a non-slip material, 23. The inner surface of the base panel 22 helps retain the pliable material 37 with which the body wedge 1 is filled. Two attachment points 17, for the grip handle 24 are shown. In the preferred embodiment, the non-slip material 23 consists of polyvinyl chloride.

Common patient care procedures using the body wedge 1 relate to methods for moving, turning, and/or positioning a patient 31 on a bed 40 or other supporting surface. The bed may include a frame and a mattress/sheet combination 36 supported by the frame.

FIG. 5 depicts a bedridden patient 31 lying prone atop a mattress/sheet 36 combination upon a bed 40, with her head 34 resting upon a pillow 30. As shown, the patient's 31 upper torso 32 and lower torso 33 are being stabilized by a first body wedge 28 and a second body wedge 29.

As shown, the first body wedge 28 is placed at least proximate the upper torso 32, or upper body, of the patient 31, while the second body wedge 29 is placed proximate the lower torso 33, or lower body of the patient 31. Each wedge 28, 29 thereby has its base panel 22 (not in view) flat upon the mattress/sheet 36 combination, while each respective sloped front panel 3 is intrinsically positioned at an approximately thirty-degree angle from the plane of the mattress/sheet 36 combination.

The base panels 22 of the bed wedges 28, 29 are formed of a non-slip material 23 having a coefficient of friction which prevents sliding along the sheet/mattress 36 combination. Caregivers are able to maneuver both bed wedges 28, 29 efficiently by grasping the grip handle 24 of each respective bed wedge 28, 29. Use of the grip handles 24 enables a sure and speedy grasping of the both bed wedges 28,29, in order to place the bed wedges 28, 29 in appropriate locations to re-position the patient 31.

The arrangement presented in FIG. 5 is, further, the starting orientation in the event caregivers need to reposition the patient 31. As necessary, either or both bed wedges 28, 29 can be placed at least partially underneath the sheet of the sheet/mattress 36 combination by inserting the front edge 4 of either or both body wedges 28, 29 underneath an edge of the sheet from a first side of the bed 40. This results in the base panel 22 resting fully on the supporting surface of the mattress/sheet 36 combination, with the sloped front panel 3 underneath the sheet. The base panel 22 of each body wedge 28, 29 has a higher coefficient of friction than the bedsheet, and thereby resists sliding of the base panel 22 across the bedsheet. As can be seen in FIG. 5, the position of the grip handles 24 at the bottom plane of the base panel 22 (out of view) gives a caregiver(s) more leverage in positioning either or both patient body wedges 28, 29 during the shifting of the patient's 31 body. The horizontal orientation of both grip handles 24 can disperse more hand and arm strength along the plane of the base panel 22 or the sloped front panel 3, thereby more easily moving either patient body wedge 28, 29 linearly away from, or upwards toward, the body of the patient 31.

The bed 40 of a patient 31 normally has a bedsheet covering a mattress, as shown in FIG. 5. In referring to FIG. 5, at least one caregiver, by grasping the grip handles 24 of either or both of the body wedges 28, 29, can then insert the body wedges 1 underneath a first edge 38 of the sheet of the sheet/mattress 36 combination. The first edge 36 of the sheet is then moved toward the rear surface 21 of each of the body wedges 28, 29 by pulling on the first edge 38 of the sheet at least partially up the sloped front panel 3 of the first body wedge 28. This results in the rear surface 21 and sloped front panel 3 of the first body wedge 28 partially supporting the upper torso 32 of the patient 31 and the sloped front panel 3 of the second body wedge 29 partially supporting the lower torso 33 of the patient 31. The patient 31 will then lie in an angled position.

To reposition the patient 31 to a posture of lying on his/her back, both wedges 28, 29 are removed, thereby allowing the patient 31 to lie fully on his/her back. To reposition the patient 31 so as to lie on the opposite side of the body, the preceding sequence is repeated, by turning the patient 31 on his/her back, then inserting each of the body wedges 28, 29 underneath the second edge 39 of the bedsheet.

While preferred embodiments of the present inventive method have been shown and disclosed herein, it will be obvious to those persons skilled in the art that such embodiments are presented by way of example only, and not as a limitation to the scope of the inventive concept. Numerous variations, changes, and substitutions may occur or be suggested to those skilled in the art without departing from the intent, scope, and totality of this inventive concept. Such variations, changes, and substitutions may involve other features which are already known per se and which may be used instead of, in combination with, or in addition to features already disclosed herein. Accordingly, it is intended that this inventive concept be inclusive of such variations, changes, and substitutions, as described by the scope of the claims presented herein.

What is claimed is:

1. An angular-shaped, padded wedge for use as stabilization support for a bed-ridden patient, the padded wedge having a quantity of pliable material enclosed interiorly, the padded wedge comprising
(a) a continuous, rectangular shaped segment of material having a right lateral edge, a left lateral edge, a front edge, and a rear edge, wherein the segment of material is extended and formed, longitudinally, into a sloped planar front surface, a curved rounded apex, and a vertically-oriented rear surface;
(b) a frontward-sloping left side conjoined with the left lateral edge of the planar front surface;
(c) a frontward-sloping right side conjoined with the right lateral edge of the planar front surface;
(d) a horizontally-oriented, rectangular base panel having an outer surface and an inner surface, wherein the base panel is sequentially connected, by stitched seams, to the front edge of the planar front surface, the bottom of the left side, the bottom of the rear surface, and the bottom of the right side;
(e) a non-slip material affixed to the outer surface of the base panel;
(f) a notification in writing, on the sloped planar front surface, indicating that the planar front surface functions as the “patient side” of the padded wedge, and
(g) a grip handle fixed midway along the exterior rear edge of the base panel.

2. The padded wedge of claim 1, wherein the pliable material enclosed within the padded wedge comprises polyurethane foam.

3. The padded wedge of claim 1, wherein the sloped planar front surface is constructed at an angle of thirty degrees relative to the horizontally-oriented base panel.

4. The padded wedge of claim 1, wherein the notification on the sloped planar front surface is written in any one of a language selected from the group consisting of English, Mandarin Chinese, Spanish, French, Standard Arabic, Bengali, German, Bengali, Portuguese, Indonesian, Dutch, Bulgarian, Danish, Hebrew, Japanese, Italian, Swedish, Swahili, Turkish, and Ukrainian, and Vietnamese.

5. A stand-alone, sanitizable, sloped body wedge for use as a body stabilizing device and as a mechanism for repositioning a bedridden person, the body wedge comprising:
an enclosed structure containing pliable material, the structure formed of a horizontally-oriented rectangular base panel, an extended rectangular, sloped front panel having a first lateral edge, a second lateral edge, a left longitudinal edge, and a right longitudinal edge, a vertical left sidewall shaped essentially as a right triangle having a horizontal long leg, a vertical short leg, and a leg equivalent to a hypotenuse, and a rounded upper apex, and a vertical right sidewall shaped essentially as a right triangle having a horizontal long leg, a vertical short leg, and a leg equivalent to a hypotenuse, and a rounded upper apex, wherein:
(a) the projected intersection of the vertical short leg of the left sidewall and its hypotenuse is constructed as a rounded apex;
(b) the projected intersection of the vertical short leg of the right sidewall and its hypotenuse is constructed as a rounded apex;
(c) the left longitudinal edge of the top panel is connected, by a seam, sequentially to the hypotenuse of the left sidewall, the upper apex of the left sidewall, and the short leg of the left sidewalk
(d) the right longitudinal edge of the top panel is connected, by a seam, sequentially to the hypotenuse of the right sidewall, the upper apex of the right sidewall, and the short leg of the right sidewall;
(e) first lateral edge of the top panel is connected, by a seam, to the front edge of the base panel;
(f) the second lateral edge of the top panel is connected, by a seam, to the rear edge of the base panel, thereby forming a rear surface panel; (g) a grip handle connected, by a seam, midway along the rear edge of the apparatus; whereby
i) the left lower edge and right lower edge of the body wedge are parallel and mutually coextensive, ii,) the front edge and rear edge of the body wedge are parallel and mutually coextensive, and iii) the left vertical rear edge and right vertical rear edge of the body wedge are parallel and mutually coextensive.

6. The body wedge of claim 5, wherein the pliable material enclosed within the body wedge comprises polyurethane foam.

7. The body wedge of claim 5, wherein the sloped planar front surface is constructed at an angle of thirty degrees relative to the horizontally-oriented base surface.

8. The body wedge of claim 5, wherein a notification, reading “patient side” on the sloped planar front surface is written in any one of a language selected from the group consisting of English, Mandarin Chinese, Hindi, Spanish, French, Standard Arabic, Bengali, German, Bengali, Portuguese, Indonesian, Dutch, Bulgarian, Danish, Hebrew, Japanese, Italian, Swedish, Swahili, Turkish, and Ukrainian, and Vietnamese.

9. An improved patient bed wedge apparatus of the type commonly used as a support cushion, patient positioning aid, rehabilitation bed wedge, or similar function, the apparatus commonly known having a flat base panel for horizontally positioning upon the surface of a bed, a vertical surface conjoined with the bottom surface, the vertical surface extending upward from the bed surface, a left surface, a right surface, and a sloped planar surface, the sloped planar surface functioning as the surface placed in abutment to some portion of a patient's body, wherein the improvement comprises:
(a) a rounded apex structure fabricated at the projected intersection of the sloped planar surface and the vertical surface, wherein the rounded apex conjoins the vertical surface and the sloped planar surface and coextensive with the width of the bed wedge;
(b) a “patient side” notification in writing, placed on the sloped planar surface; and (c) a grip handle affixed at two attachment points, to the rear edge of the bottom surface, the attachment points being linearly parallel to the edge of the base panel.

10. The body wedge of claim 9, wherein the pliable material enclosed within the body wedge comprises polyurethane foam.

11. The body wedge of claim 9, wherein the sloped planar front surface is constructed at an angle of thirty degrees relative to the horizontally-oriented base panel.

12. The body wedge of claim 9, wherein a notification, reading “patient side” on the sloped planar front surface is written in any one of a language selected from the group consisting of English, Mandarin Chinese, Hindi, Spanish, French, Standard Arabic, Bengali, German, Bengali, Portuguese, Indonesian, Dutch, Bulgarian, Danish, Hebrew, Japanese, Italian, Swedish, Swahili, Turkish, and Ukrainian, and Vietnamese.

13. A method for efficiently and comfortably moving or turning the body of a bedridden patient lying horizontally atop a mattress and sheet, comprising the steps of
(a) providing a first angular-shaped, padded wedge, and a second angular-shaped padded wedge, each padded wedge identically comprising (i) a sloped, fiat planar front surface, (ii) a rounded apex connecting the sloped, flat front surface to an integral vertical rear surface; (iii) identical left side and right sides, (iv) a horizontally-oriented base panel having a non-slip material affixed to the exterior surface of the base panel, and further, the base panel being sequentially connected by stitched seams to the flat planar front surface, the left side, the rear surface, and the right side of the padded wedge; and (v) a grip handle fixed midway along the rear edge of the base panel of each, the first padded wedge and the second padded wedge thereby providing more leverage;
(b) placing the base panel of the first padded wedge upon the mattress/sheet, while simultaneously placing the sloped flat planar front surface of the first padded wedge proximate the upper torso of the patient, and afterward, placing the base panel of the second padded wedge upon the mattress/sheet, orienting the flat planar front surface of the second padded wedge in partial contact with the lower torso of the patient;
(c) grasping the grip handle of the first padded wedge while simultaneously turning the patient away from the front surface of the first padded wedge so as to cause the patient to lie in an angled position;
(d) as necessary, placing the front surface of the second padded wedge proximate the lower back area of the patient, while simultaneously placing the bottom surface of the second padded wedge in full contact with the sheet atop the mattress;
(e) grasping the grip handle on each the first padded wedge and second padded wedge, thereby positioning the first padded wedge and second padded wedge in abutment to the patient's body such that both padded wedges function in the manner of a lever for moving the patient's body about the longitudinal axis of the patient's body.

14. The padded wedge of claim 13, wherein the pliable material enclosed within the padded wedge comprises polyurethane foam.

15. The padded wedge of claim 13, wherein the sloped planar front surface is constructed at an angle of thirty degrees relative to the horizontally-oriented base panel.

16. The padded wedge of claim 13, wherein the notification on the sloped planar front surface is written in any one of a language selected from the group consisting of English, Mandarin Chinese, Hindi, Spanish, French, Standard Arabic, Bengali, German, Bengali, Portuguese, Indonesian, Dutch, Bulgarian, Danish. Hebrew, Japanese, Italian, Swedish, Swahili, Turkish, and Ukrainian, and Vietnamese.
